(19) United States
(12) Patent Application Publication
(10) Pub. No.: US 2015/0126101 A1
(43) Pub. Date: May 7, 2015

(54) DEVICE FOR TREATING A STRING OF SAUSAGES

(71) Applicants: Singer & Sohn GmbH, Berching (DE); HOWE Wurstwaren KG, Nurnberg (DE)

(72) Inventors: Manfred SINGER, Berching (DE); Dieter KOLLER, Sulzburg (DE)

(21) Appl. No.: 14/531,033

(22) Filed: Nov. 3, 2014

(30) Foreign Application Priority Data
Nov. 5, 2013 (DE) 10 2013 112 141.1

(51) Int. Cl. A22C 11/10; A22C 13/00; H05B 6/64; A22C 11/00

(52) U.S. Cl. CPC A22C 11/10; A22C 11/008; A22C 13/00; H05B 6/645
USPC 452/51

(57) ABSTRACT

Device for treating a string of sausages composed of a plurality of sausages which are disposed so as to be behind one another, having a sausage casing from an organic material which in the region between two sausages displays in each case a twist, wherein at least one microwave applicator which has at least one application chamber and is assigned at least one microwave generation unit for generating the microwave radiation to be supplied to the application chamber, and which has at least one conveying unit for conveying the string of sausages through the at least one application chamber is provided, wherein at least one measuring unit (28, 29) for identifying at least one measured value which represents a measure of the temperature prevailing in the application chamber (11) is provided.

The invention relates to a device for treating a string of sausages composed of a plurality of sausages which are disposed so as to be behind one another, having a sausage casing from an organic material which in the region between two sausages displays in each case a twist, wherein at least one microwave applicator which has at least one application chamber and is assigned at least one microwave generation unit for generating the microwave radiation to be supplied to the application chamber, and which has at least one conveying unit for conveying the string of sausages through the at least one application chamber is provided.

In order to manufacture sausages, the sausage meat, by means of a filling machine, is usually pressed through a filling tube into a hose-shaped sausage casing. The individual sausage portions, that is to say the individual sausages, are formed by means of a twisting mechanism, in that the string of sausages is twisted such that the string is locally constricted while forming a twist in the sausage casing. The individual sausages are thus separated from one another by such a twist in the casing. The string of sausages thus formed is then severed by means of a singularization device. To this end, the string of sausages is gripped by a conveying unit, usually two conveyor belts, which conveys the string sausages at a defined speed to an singularization device, for example a cutting unit, where the individual sausages are severed in the region of the twist. In the case of a cutting unit, two counter-rotating knives which interact for cutting are usually employed.

In the case of many varieties of sausages, an animal intestine, that is to say an organic intestine material, is used as sausage casing. Since this is a natural material, it inevitably does not display a homogenous thickness; rather, the material thickness varies across the length of the intestine. In the region of the twists, that is to say where the intestine has been twisted together, a comparatively thick material section results, on the one hand, and the thickness of the latter, on account of variable thicknesses of the intestine, may vary from twist to twist, on the other hand. The intestine material is also very soft and elastic. These conditions mean that high requirements are set for the cutting unit; in other words, the knives or the knife, respectively, and a potential anvil block have to cut with extreme accuracy and with a high cutting force in order to ensure complete severing. The cutting unit also has to be capable of readily and reliably severing various thicknesses of twists. Alternatively, a man-made casing material which is also to be cut in the region of the twists may also be used to separate the sausages, wherein on account of the elasticity of the man-made material high requirements are set for the cutting unit here, too.

Besides the use of a mechanical cutting unit, it is furthermore known for a singularization of the sausages to be implemented by way of the application of microwave radiation. For this purpose, devices which display at least one microwave applicator having at least one application chamber are known. The microwave radiation is generated by means of a microwave generation unit, that is to say a suitable magnetron, and supplied to the application chamber. By means of a suitable conveying unit, the string of sausages is conveyed to the application chamber and therethrough. The microwave radiation which is rich in energy is applied in the application chamber. By way of this microwave radiation, a thermal treatment of the string of sausages, i.e. introducing microwave energy thereto, takes place, which leads to the material being heated. This microwave radiation can only be applied in the region of the twists by way of a corresponding activation of the microwave generation unit, that is to say that the radiation is generated in a cyclical manner, to which end, by way of suitable identification unit (sensor system), the presence a twist in the application region, that is to say in the application chamber, is identified. However, the microwave radiation is preferably supplied in a continuous manner, that is to say that the entire string of sausages, sausages and twists, are impinged by means of the microwave radiation. During radiation, an application of energy which leads to the material being heated arises. Since the casing material is either a natural, organic material, namely animal intestine, or a man-made intestine, that is to say a likewise organic man-made material, on account of the application of energy and the heating resulting therefrom, a modification of the material or the material structure, respectively, takes place. In the case of the animal intestine, a coagulation process is initiated, that is to say that the structure of proteins is modified and the latter coagulate. This process commences at a temperature of usually more than 40° C. The more energy is applied, the greater the heating, and the more intense the coagulation process. In turn, this coagulation leads to the material embrittling or hardening, respectively, that is to say that the organic casing material becomes rigid and its flexibility becomes variable. In the case of a man-made intestine, the application of energy and the heating leads to a breakdown of the bonds and to cross-linking processes, on account of which an embrittlement likewise implements. The greater and the more rapid the application of energy, the greater the degree of coagulation or cross-linkage, and the greater the degree of the onset of embrittlement seen in the cross section. This embrittlement extends, that is to say that so much energy is applied, that fracturing and thus automatic singularization of the sausages result. By way of the application of microwave radiation a non-contacting singularization of the sausages is thus possible. The output of the microwave generation unit here should be 1-50 kW, preferably 3-30 kW and should be correspondingly adjustable in order to ensure that a sufficiently high application of energy is possible at all times.

As described, in order to manufacture a string of sausages, the sausage meat is filled into the intestine. The manufactured twisted string of sausages then travels through the application chamber. It may happen that some sausage meat leaks during the filling process, that is to say is not enclosed by the intestine casing, in particular when a new piece of intestine is attached when an animal intestine is being filled. This exposed sausage meat, so to speak, now likewise travels into the microwave applicator and in particular into the application chamber where it occasionally gets caught, so that the application chamber is polluted. This is undesirable, since in the context of foodstuffs manufacturing, in particular in the case of the present sector of meat processing, an extremely high degree of cleanliness is demanded.

The invention is thus based on the object of providing a device for treating a string of sausages with a microwave applicator in which microwave radiation is applied to the string of sausages, which is improved in comparison to known devices and enables a given accumulation of organic material in the application chamber to be identified.

In order to achieve this object in a device of the type mentioned at the outset, according to the invention at least one measuring unit for identifying at least one measured value which represents a measure of the temperature prevailing inside the application chamber is provided.

The device according to the invention distinguished in that by means of a measuring unit a measured value which is a direct or indirect measure of the temperature prevailing in the application chamber is recorded. This is based on the finding that sausage meat, that is to say organic material, which accumulates in the application chamber, polluting the latter, is permanently exposed to the microwave radiation to be supplied to the application chamber. In contrast to the string of sausages rapidly passing through, this results in prolonged radiation and thus heating of this organic material. Since the latter is remanent in the application chamber, the atmosphere of the chamber is also heated as a result. In the extreme case, this heating up may even go so far that the organic material becomes very hot and completely decomposes and even is scorched, that is to say consequently becomes very hot.

On account of the use of the integrated measuring unit according to the invention it is now possible for a continuous monitoring of temperature to be performed. In the context thereof, measured values which represent a corresponding measure of the chamber temperature are continuously recorded. Should it result by way of a corresponding processing of these measured values that the latter indicate an increase in temperature beyond a defined nominal temperature, it is ensured that this can be traced back to pollution of the interior of the application chamber by way of organic material adhering thereto. After all, the string of sausages which continuously travels through the application chamber at high speed cannot alone make for a corresponding increase in temperature. If and when such a situation having an identified temperature which is higher than a reference temperature is determined, the operation is correspondingly controlled by way of a suitable controller which, for example, performs this evaluation of measured values, in that, for example, the generation of microwaves is abruptly terminated, just as further conveying of the string of sausages is also stopped. Of course, a corresponding stoppage of the conveyor has an effect on upstream and, if applicable, downstream peripheral equipment; these also have to be correspondingly controlled.

On account of the corresponding controller intervention, in particular in the case of an operational stoppage, the microwave applicator may now be correspondingly opened and cleaned out in the chamber region, that is to say the adhering organic material is removed from the application chamber.

The integration according to the invention of the measuring unit and thus the continuous monitoring of temperature thus particularly advantageously permits monitoring of the application chamber which, during operation, is of course closed and not visible, with regard to potential pollution. As a result, such pollution may be identified at a very early stage, since, on account of the continuous heating of the polluting organic material, a potential increase in temperature can be established very early and in a sensitive manner. In particular, it can be avoided in this way that extreme heating up of this polluting organic material, right up to the latter being scorched, takes place. This means that, on account of the integration of the at least one measuring unit, a fire prevention measure is also provided, or fire monitoring is possible, respectively.

The measuring unit itself may identify the measured value as a measured value of temperature directly in the interior of the application chamber. According to an alternative of the invention, a measuring unit which enables direct measurement of temperature in the interior of the chamber is used. To this end, a sensor element which is connected to a corresponding measuring circuit outside the chamber is disposed in the interior of the chamber. The sensor element is to be preferably positioned at a spot where it is impinged by as little microwave radiation as possible but nevertheless communicates with the interior of the chamber in order to identify the temperature. An optical measuring unit, that is to say one that operates in a non-contacting manner, in particular an infrared measuring unit, which identifies and evaluates the surface temperature of a wall of the application chamber, for example, is usable. This measuring unit having an optical measuring system may be disposed such that it identifies a chamber wall over an extensive area, even when the sensitive microelectronic parts are disposed outside the region of radiation.

It is preferable, however, for the measuring unit to identify the measured value as a measured value of temperature of a component which lines or delimits the application chamber. That means that an indirect measurement of temperature of the chamber temperature, so to speak, takes place in that the temperature of a component located in the application chamber is identified. In order to avoid that the measuring unit or a corresponding sensor is to be disposed in the interior of the chamber, according to a particularly preferred embodiment, the measured value of temperature is identified on the outer side of the component, thus on the side which does not face toward the interior of the chamber. Such a component is preferably, but not limited thereto, a rail which is accommodated in the application chamber and which lines or penetrates the latter and is disposed so as to be adjacent the string of sausages running past. Since it lines or delimits the chamber, such a rail which is composed of a suitable material which is transparent to microwave radiation is inevitably exposed to the increasing temperature in the event of meat adhering in the chamber. Since the material of the rail is comparatively thin, consequently a corresponding increase in temperature may readily also be identified on the outer side of the rail, wherein, of course, by way of the controller which processes the measured values and in conjunction with the specific material parameters of the material of the rails (thermal conductivity, etc.) the measured external temperature is extrapolated to obtain the prevailing interior temperature. With regard to the specific embodiment of this indirect temperature measurement by identifying the external temperature of such a rail-type component, more details will be explained in the following.

For reasons of redundancy, on the one hand, and of course also because sausage meat may adhere to various sides of the application chamber on the other hand, it is expedient for two measuring units which are disposed at two different positions and which identify in each case a measured value of temperature of the or in each case one component, thus for example such a rail, to be provided. As a conveying unit, preferably a belt conveyor having two conveyor belts lying on top of one another is used, which conveyor belts preferably run through the application chamber. Said conveyor belts lie on top of one another, that means that adhering is not possible in relation to the vertical. The two components are disposed so as to be horizontally spaced apart in relation to one another; they are thus to the side of the string of sausages, so to speak. Sausage meat may adhere in this region, which is why the corresponding measuring units are accordingly positioned and record the corresponding measured values for temperature at the two different positions, respectively.

In the case of an indirect measurement of temperature on a component, in particular the outer side thereof, an optical measuring unit which operates in a non-contacting manner, in particular an infrared measuring unit, is preferably used as a measuring unit. This measuring unit comprises a corresponding optical measuring system which makes it possible for the actual sensor or the corresponding measuring circuit, respectively, to be disposed outside and at sufficient spacing from the application chamber where a high radiation density prevails. The optical measuring unit, in particular in the form of an infrared measuring unit, identifies the surface temperature of the component, preferably in the manner described on the outer side of the component, in order to record the measured value of temperature. As an alternative the use of an optical measuring unit which operates in a non-contacting manner, it is conceivable for the measuring unit be a measuring unit which bears on the component in a contacting manner, in particular glass fibers which bear on the component in a comprehensive manner. According to this embodiment of the invention, a fiber-optic measurement of temperature in which, for example, a bundle of glass fibers which are shrouded in PTFE is guided to the component is employed. By way of the bundle of glass fibers, there is, in turn, an optical coupling to the component which enables an identification of the temperature. Preferably, however, an optical measuring unit which operates in a non-contacting manner, in particular in the form of an infrared measuring unit, is used, since by way of a suitable optical measuring system the optically identified region can be correspondingly zoomed, so that monitoring of temperature over an extensive area is possible.

As already described, according to a particularly advantageous refinement, the or each component is a rail which is composed of a material which is transparent to microwave radiation and is releasably disposed in the microwave applicator, and which is disposed so as to be adjacent to the string of sausages in the application chamber. As embodied, preferably two such rails are used, wherein either a measuring unit is assigned only to one rail but preferably to both rails. Since the conveying unit with its two conveyor belts preferably runs through the application chamber, these rails are positioned so as to be laterally horizontal beside the string of sausages, wherein the corresponding measuring units are disposed in a further horizontal extension.

Particularly preferably, two rails which display a C-shaped cross section and are disposed so as to face one another in the microwave applicator in such a manner that, at least in the application chamber, they form a tubular hollow space, which is preferably rectangular in the cross section, through which the string of sausages runs, are provided. These two C-shaped rails which preferably have a rectangular C-shaped cross section thus abut one another by way of their two lateral legs, such that a tubular hollow space results. The two conveyor belts of the continuous conveying unit preferably run through said hollow space, one conveyor belt adjacent to the two lower rail legs which abut one another, the upper conveyor belt adjacent to the two upper rail legs which abut one another. In this manner it is excluded that sausage meat adheres below and above the conveyor belts. The measuring unit(s) now identifies (identify) the temperature, preferably the outside temperature of the centric C-leg or the centric C-legs of the rails which are laterally disposed in relation to the string of sausages. By way of this hollow space which is laterally closed off, the volume in which polluting sausage meat may accumulate can be advantageously reduced.

As embodied, the two rails are releasably disposed in the microwave applicator (of course, the same applies in the case of only a single rail being used), so that they may be readily removed and cleaned in the event of polluting having been determined. Since they preferably form a closed tubular hollow space in the application chamber, cleaning of these two rails alone concludes cleaning of the chamber, since any sausage meat can only adhere to the rail side as the string of sausages runs through the hollow space.

Preferably, the or at least one of the two, preferably both rails, at least in portions, in the region which is disposed in the application chamber display/displays a lesser wall thickness than in the other regions. This serves for increasing the transparency to microwaves of the rail material which is already transparent to the largest extent.

The one, or both, respectively, rails here may be designed such that they are ultimately only disposed in the region of the application chamber but otherwise do not extend further through the microwave applicator. However, preferably the rails, at least in portions, extend longitudinally through the microwave applicator, depending on how long or by way of how many different application chambers, respectively, said microwave applicator has been embodied, this to be discussed in more detail in the following.

The microwave applicator itself preferably is composed of two parts which are movable apart for opening, wherein the one part is positionally fixed and is connected to a hollow conductor which leads to the microwave generation unit, while the other part is movably mounted, and wherein the measuring unit which measures the temperature on the outer side of either the rail which is directed toward the movable part or on the rail disposed thereon is disposed on the movable part and, by way of an optical measuring system, is directed toward the rail or, in the event of a contacting measuring unit being used, with its corresponding measuring part is guided to the rail. Of course, the microwave applicator has to be able to be opened in a corresponding manner in order to access the application chamber and to be able to clean said application chamber or to remove and clean the components installed therein, that is to say the rails, respectively. To this end, part of the microwave applicator which is usually embodied as a front plate which is mounted so as to be pivotable or movable in a linear manner, can be correspondingly removed from the positionally fixed other applicator part, such that the applicator is opened. The one or both rails may now be readily removed. If the two C-shaped rails are employed, as described, at least one measuring unit is disposed on the movable part and, with its optical measuring system, directed toward the rail. This rail itself may be disposed together with the second rail on the positionally fixed applicator part; however, said rail may also move together with the movable part when the two parts are moved apart.

Alternatively or additionally, a (second) measuring unit which is disposed outside the hollow conductor and which is either, by way of an optical measuring system, directed through the hollow conductor toward the rail or, with a corresponding measuring part guided through the hollow conductor to the rail may be provided. Since the second C-shaped rail is disposed on the positionally fixed part and delimits the chamber in relation to the hollow conductor, the (second) measuring unit is consequently disposed in a horizontal extension, so to speak, outside the hollow conductor and accordingly, by way of its optical measuring system, directed toward the rail with the bundle of glass fibers, guided to the rail, respectively.

The rails may be composed various materials, wherein, of course, a material which is sufficiently transparent to microwave radiation, on the one hand, and is temperature resistant, on the other hand, is to be used, since it has to be ensured that even in the event of the adhering organic material being scorched or burned and thus of the significantly high temperatures prevailing, no damage to the material of the rails arises. For this purpose, the rails may be composed of polytetrafluoroethylene (PTFE), schist, fused quartz, aluminum oxide, zirconium oxide, or ceramic based on aluminum oxide or zirconium oxide. In particular, the use of polytetrafluoroethylene is particularly advantageous, since this is a man-made material which has an only very slight tendency to break. Moreover, it is also non-flammable and is sufficiently temperature-resistant; it readily resists temperatures of 250° C., for example. The other materials mentioned also have corresponding properties; on the one hand, they are non-flammable, but on the other hand, they are also highly temperature-resistant, schist, for example, up to 500° C., while the other materials, that is to say glass, the metallic oxides and the ceramics, respectively, are resistant to temperatures well above 1000° C.

In a simple embodiment, the device according to the invention may display a microwave applicator having only one application chamber with a correspondingly assigned microwave generation unit. Alternatively, a plurality of application chambers which are disposed so as to be behind one another and which are supplied microwave radiation from a common microwave generation unit or from in each case separate microwave generation units may be provided in the microwave applicator, wherein at least one part, preferably each application chamber, is assigned at least one measuring unit. For example, the microwave applicator may thus display two, three, or four application chambers which are disposed so as to be behind one another and which are in each case fed from a separate microwave generation unit, for example. Preferably, each application chamber is assigned at least one measuring unit, preferably of course two measuring units, in particular if each application chamber is lined with the two mentioned C-shaped rails. After all, it is in principle conceivable adhering sausage meat to also only drop off the string of sausages in a downstream application chamber and to adhere there.

Where a plurality of application chambers are employed, it is particularly expedient for one or both rails to run through a plurality of application chambers. By way of employing two longer rails, on the one hand, to implement a correspondingly long hollow space which is duct-like and easy to clean and through which, besides the conveyor belts, the string of sausages runs, on the other hand, also two or more corresponding chambers may be simultaneously lined. If four application chambers are provided, for example, four rails can be used, wherein one pair of rails in each case extends through two application chambers.

As described, the provided conveying unit preferably comprises two conveyor belts which are disposed so as to be beside one another and which, on the sides which face one another, are accordingly profiled in order to accommodate and convey the string of sausages in a correspondingly secure manner between them. The conveyor belts are guided by way of corresponding rollers and are simultaneously driven, so that they revolve at an identical speed. The string of sausages is located between the leaders which face one another. The two belts run through the at least one application chamber or, if provided, the plurality of application chambers, and through the respective hollow space which is formed by way of the C-shaped rails, respectively. The conveyor belts themselves are preferably from silicone, that is to say a sufficiently flexible material which may be readily structured in order to configure the corresponding surface profile. Alternatively, each conveyor belt may also be composed of a flexible carrier belt, for example from PU, and a silicone coating applied thereon.

Finally, according to the invention, a controller which upon identification of a measured valued which indicates a temperature which exceeds a reference value switches off the one microwave generation unit or the plurality of microwave generation units and, of course, also expediently stops the corresponding conveying unit, that is to say the drive of the conveyor belts, is provided. The controller evaluates the measured values supplied and compares the latter to a corresponding reference value in order to determine by means of this comparison whether an increased chamber temperature which requires intervention prevails or not. Of course, it is also conceivable for the individual measuring units to themselves perform this comparison and to supply the corresponding result of the comparison to the controller which, by means of this result of the comparison, intervenes in a controlling manner, if applicable.

Further advantages, features and details of the invention are derived from the exemplary embodiments described in the following and by means of the drawings, in which

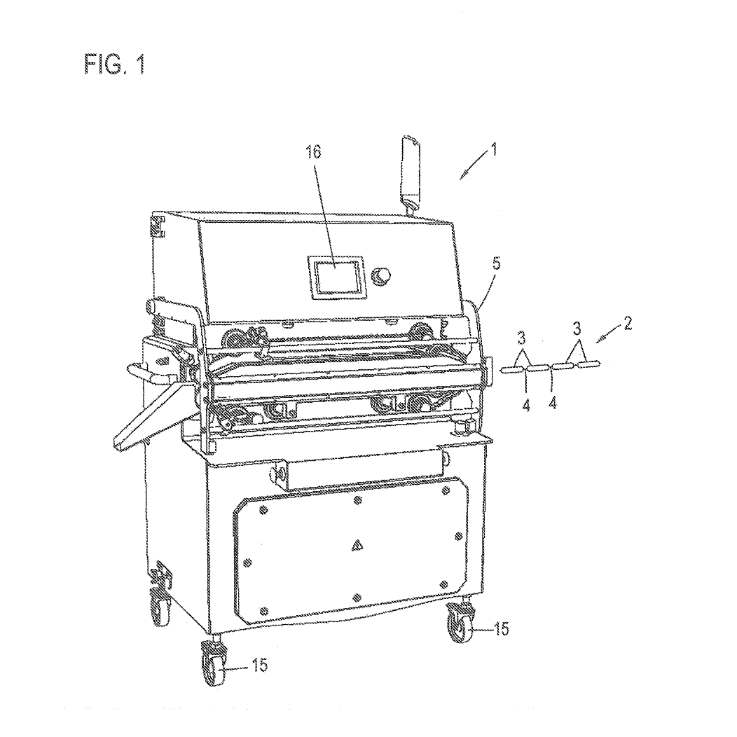

FIG. 1 shows a perspective view of a device according to the invention;

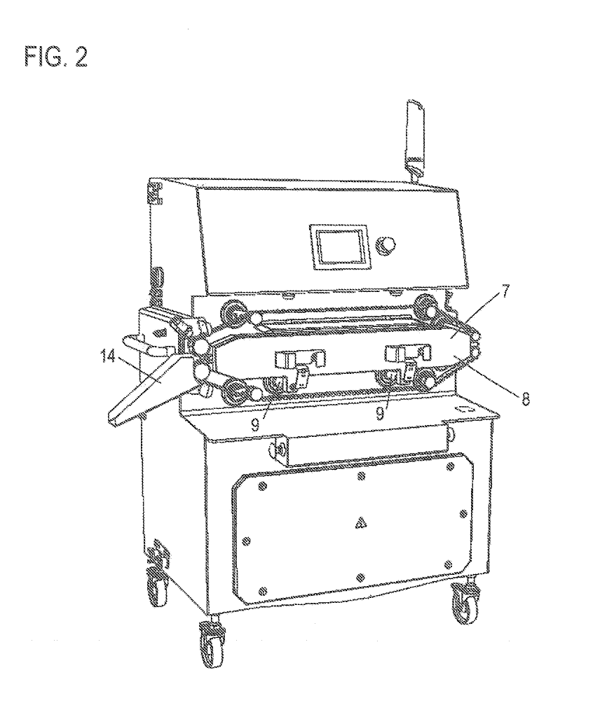

FIG. 2 shows the device from FIG. 1, without the safety frame;

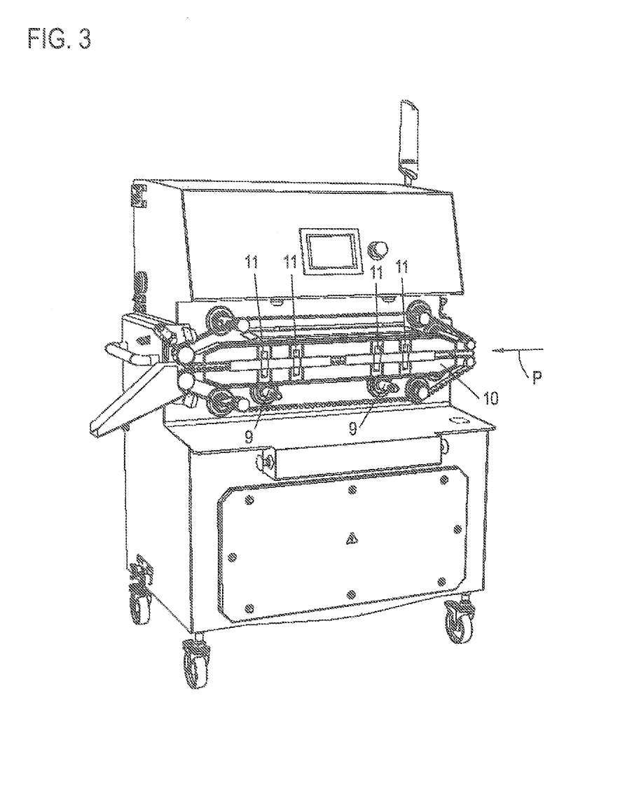

FIG. 3 shows the device from FIG. 2, with the microwave applicator shown as being opened;

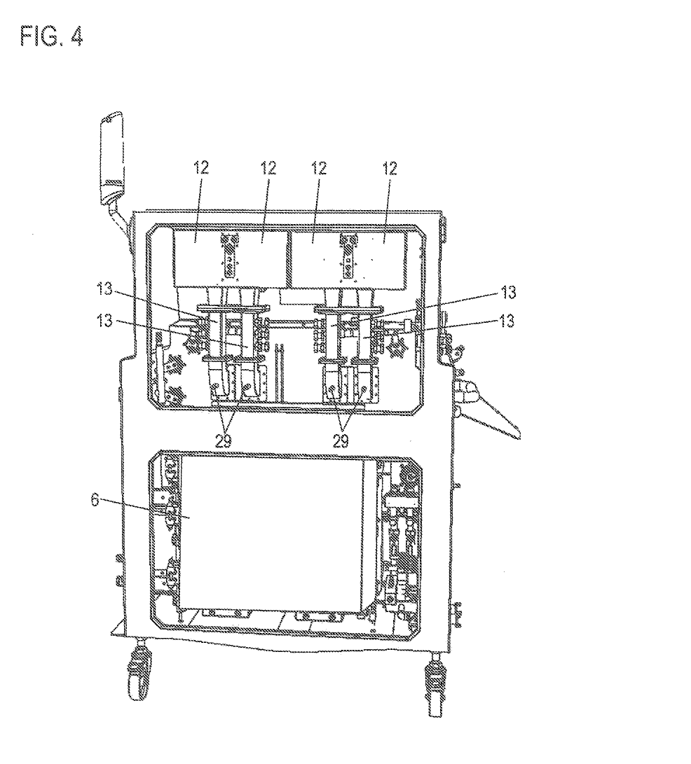

FIG. 4 shows the device from FIG. 3, with the opened rear side;

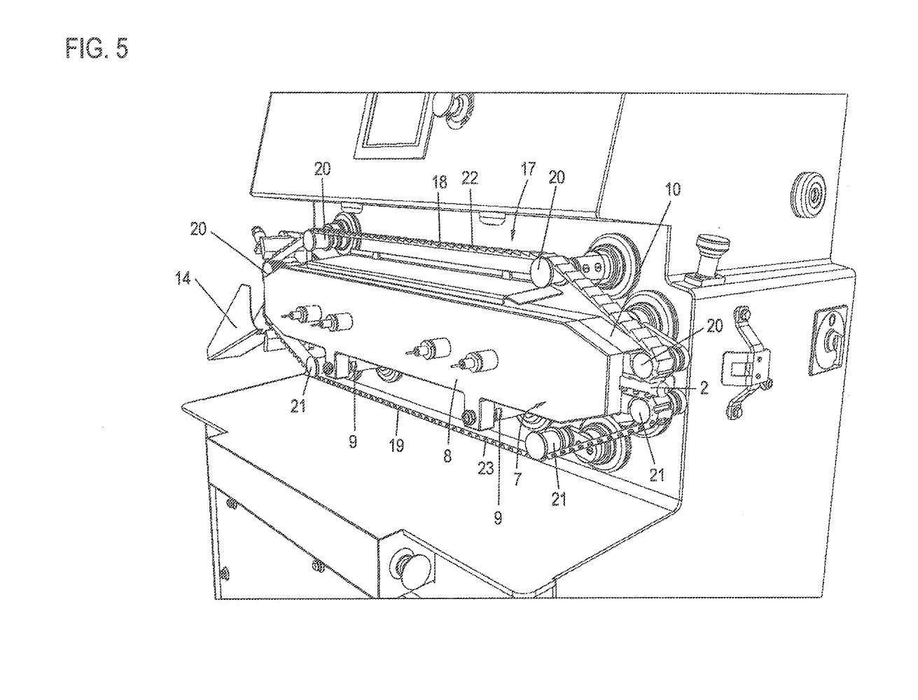

FIG. 5 shows a partial view of the device according to the invention, with an illustration of the microwave applicator in the closed state;

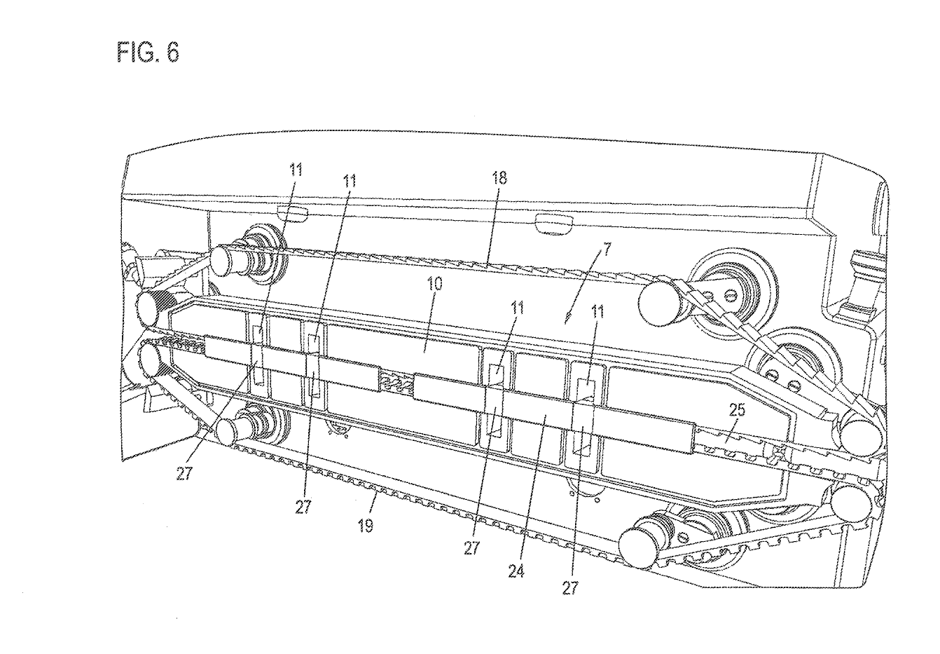

FIG. 6 shows a partial view of the device according to the invention, with the opened microwave generator, in order to illustrate the application chambers plus rails; and

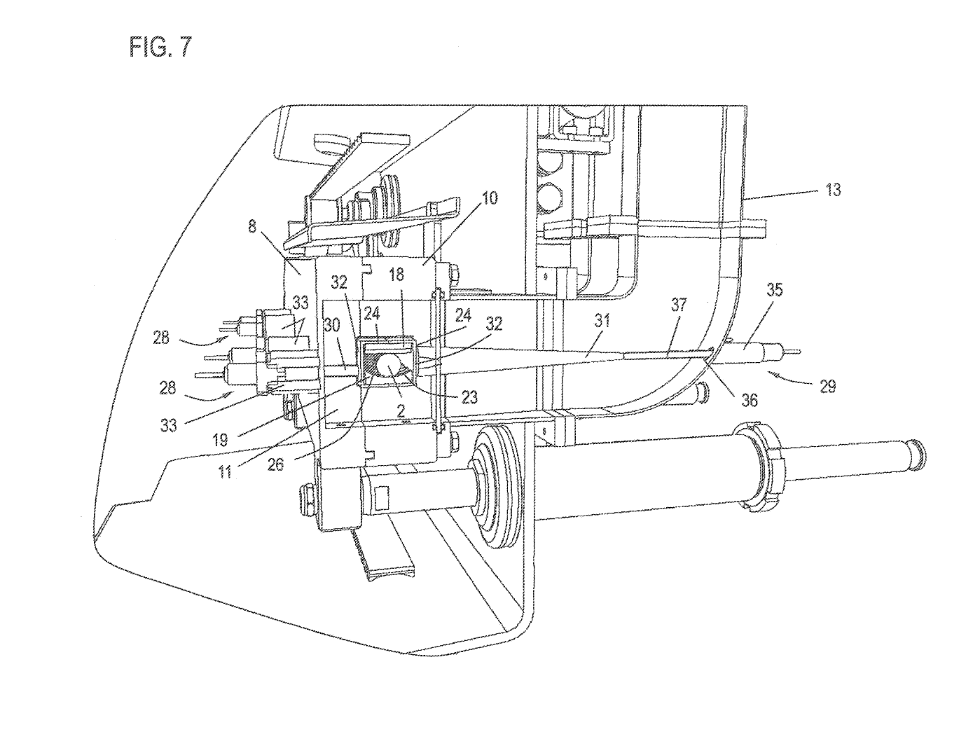

FIG. 7 shows a partial view of the device according to the invention, in a partial section, in order to illustrate the arrangement of two measuring units which are in each case assigned to one application chamber.

FIG. 1 shows a device 1 according to the invention, which serves for treating a string of sausages 2 which is composed of a plurality of sausages 3 which are disposed so as to be behind one another, having a sausage casing from an organic material which in the region between two sausages 3 displays in each case a twist 4. In operation, the device 1 applies microwave radiation, that is to say that the string of sausages 2 is conveyed at high speed (approx. 600 sausages per minute, if and when required even more) through the device 1 and is thereby exposed to microwave radiation. This microwave radiation serves to denaturalize, that is to say locally embrittle, the sausage casing, that is to say the organic material, in particular in the region of the twists 4, such that by way of this microwave treatment alone the sausages 3 are singularized and exit from the device 1 in an individual manner.

FIG. 1 shows the device 1 according to the invention in a comprehensive illustration; the following figures in each case show reduced views or partial views, respectively.

For safety reasons, a pivot frame 5 which has to be closed for operation, this being identified by way of a suitable sensor system, is provided. The device 1 may only be started up in the first place when the safety frame is closed. Control of the device 1 takes place by way of a controller 6 (see FIG. 4) which is not shown in detail and which, of course, may be composed of a plurality of control blocks which are assigned different controlling tasks.

The device 1 displays a microwave applicator 7 which is composed of a movable part 8 which is displaceable in horizontal plane by way of linear guides 9 and a suitable linear drive (not shown in more detail), and a second part 10 (see FIG. 3) which is fixed in relation to the device. For operation, both parts have to be moved together, such that the microwave applicator is closed, this likewise being identified by way of a suitable sensor system. Operation can likewise only commence in the case of a closed microwave applicator 7.

The microwave applicator 7, see FIG. 3, for example, displays four separate application chambers 11 which, in the conveying direction of the string of sausages 2 (arrow P in FIG. 3) are consecutive. This means that the string of sausages 2 runs through all four application chambers 11, in which said string of sausages 2 is exposed to the microwave radiation. Here, both the part 8 and also the part 10 display corresponding hollow spaces which together form in each case the application chamber when the parts 8, 9 have been moved together. Chamber portions are thus in each case provided on both parts 8, 9.

A separate microwave generation unit 12 is assigned to each application chamber 11, wherein in each case two microwave generation units 12 are disposed in a common block—see FIG. 4. From each microwave generation unit 12, a hollow conductor 13 runs to in each case one application chamber 11. From the respective microwave generation unit, that is to say a sufficiently powerful magnetron, the microwave radiation is guided through this hollow conductor 13 to the application chamber.

Of course, the string of sausages 2 itself is correspondingly manufactured or prepared, respectively, prior to passing through the device 1 according to the invention. To this end, the sausage meat, by way of a filling device (not shown in more detail) is introduced into the sausage casing, usually an animal intestine, the individual twists 4 being thereafter produced by rotating the filled sausage casing with a twisting device (not shown in more detail). From the twisting device via a conveying unit (not shown), the string of sausages 2 reaches the device 1, where it is taken over from a conveying unit, which is yet to be described in the following, and is conveyed through the microwave applicator 7. The singularized sausages are delivered onto a chute 14 from where they leave the device 1 to a downstream conveying unit. The device 1 is embodied as a modular apparatus; as it is provided with corresponding casters 15, said device 1 may be readily integrated in a corresponding production line. Manipulation of the device 1 or of the controller 6, respectively, is performed via a touch screen 16, so that the user may readily intervene in the operation.

The detailed construction of the microwave applicator 7 and of the assigned conveying unit, and the arrangement of the measuring units provided according to the invention for monitoring of the temperature in the interior of application chambers 11 is obtained from FIGS. 5-7. The latter in each case show detailed views of the device 1.

FIG. 5 shows a detailed view illustrating the microwave applicator 7. The latter is closed, that is to say that the movable part 8 has been displaced so as to bear on the fixed part 10 in the operating position.

FIG. 5 shows a conveying unit 17 comprising two conveyor belts 18, 19 which are disposed so as to be on top of one another and which are in each case guided by a plurality of rollers 20, 21, wherein at least one of the rollers 20, 21 is in each case driven, such that that conveyor belts 18, 19 revolve. As is evident, the conveyor belts 18, 19, with their leaders which are adjacent to one another, run through the microwave applicator 7 and accommodate the string of sausages 2 between them. In order to reliably guide the string of sausages 2, each conveyor belt 18, 19, on that side on which the string of sausages bears, is provided with a profiling 22, 23, wherein the profiling 22 of the conveyor belt 18 is embodied as a saw-tooth profile, so to speak, while the profiling 23 of the conveyor belt 19 is embodied as a grooved profile having a curved cross-sectional structure (see FIG. 7, in particular).

The conveyor belts 18, 19 are preferably from silicone, that is to say they are sufficiently flexible. They run through the entire microwave applicator 7, that is to say that the conveying unit 17, on the entry side, conveys the still continuous string of sausages 2, while on the delivery-side end, toward the chute 14, the individual sausages are deposited by the conveying unit 17.

FIG. 6 shows an enlarged detailed view of the opened microwave applicator 7; for reasons of clarity, the movable part 8 is not shown.

The individual application chambers 11, in the shown example a total of four application chambers 11 which are consecutive and through which the two conveyor belts 18, 19 run on top of one another, are clearly visible.

Furthermore, FIG. 6 shows a total of four rails 24, wherein in each case two rails 24 which in each case display a C-shaped cross section (FIG. 7) are disposed so as to face one another. The rails 24 are disposed in a conveying duct 25 which, in the shown exemplary embodiment, is configured in the fixed part 10 of the microwave applicator 7 and which interconnects the individual application chambers 11. The rails 24, on account of their arrangement which has been chosen so they oppose one another, form a hollow space 26 which is laterally closed and through which the conveyor belts 18 and thus also the string of sausages 2 run—see FIG. 7, in particular.

As is shown in particular in FIG. 6, the respective pairs of rails 24 also run through the individual application chambers 11, that is to say that the rails 24 line the application chambers 11, so to speak, and also define a hollow space 26 which is present in the respective application chamber 11. In the regions in which the rails 24 are accommodated in the respective application chamber 11, here the regions 27, the wall thickness of the material of the rails is somewhat reduced, the rail wall, of the respective leg thus being somewhat thinner, in order to avoid compromising the supplied microwave radiation which, after all, reaches the hollow space 26, and to enable rapid heating through of the material of the rails, which plays a part in the context of the measurement of temperature and which will be discussed in the following.

The two pairs of rails 24 are evidently spaced apart somewhat from one another in the conveying direction. However, this is not mandatory. It would also be conceivable for only two but significantly longer rails which run through all four application chambers 11 to be used.

Of course, the rails 24 are from a material which does not compromise the applied microwave radiation, or does so only in a completely negligible manner. PTFE is preferably used, since this man-made material does not compromise the applied radiation, on the one hand, and is also non-flammable and can be readily removed and cleaned, on the other hand. However, other materials, for example based on ceramics or the like, are also conceivable.

The rails 24 can be readily removed. To this end, the two rails 24 which are at the front need only be pulled out of the conveying duct 25, after which the conveyor belts 18, 19 can be taken off the rollers and the rear rails 24 can be removed. The rails may thus be individually cleaned, as may also the conveying duct 25 or the application chambers 11, if and when required.

FIG. 7, in a detailed view, shows the integration of two measuring units 28, 29 according to the invention which serve for identifying measured values which represent a measure of the temperature prevailing in the respective application chamber 11. Each individual application chamber 11 is assigned two such measuring units 28, 29, wherein FIG. 7, as far as the measuring unit 29 is concerned, only shows one.

Every measuring unit 28, 29 is an optical measuring unit, in the present case preferably an infrared measuring unit. They serve for indirectly identifying the temperature, so to speak, in that the respective temperature or distribution of temperature, that is to say in a localized resolution, portions of the two rails 24 is identified. As is shown by FIG. 7, each measuring unit 28, 29 comprises an optical measuring system (not shown in more detail) which defines a conically widening measuring range 30, example, within which the respective measuring unit 28, 29 with its sensor identifies the outside temperature of the respective centric leg 32 of the two rails 24. Of course, the outside temperature correlates to the temperature in the interior of the application chamber 11, or in this case in particular of the hollow space 26, respectively. Notwithstanding the temperature thus being not directly measured in the interior but on the outside, on account of the recorded measured values the prevailing inside temperature may be readily determined, since the corresponding material parameters of the material of the rails are known, in particular as far as the thermal or temperature conductivity is concerned, so that a corresponding calculation of the actual temperature is possible. Since the identification of the temperature takes place in the regions 27 of each rail 24, which are thin in terms of wall thickness, a rapid heating through and thus an accurate determination of the temperature is possible.

The measuring units 28, 29 thus record the outside temperature of the rails 24 or of the legs 32, respectively, over an extensive area. This outside temperature remains constant during operation. However, an increase in temperature may arise when sausage meat which adheres on the outside on the string of sausages 2, for example, accumulates in the application chamber 11 or, in this case, in the hollow space 26, respectively, in as far as the latter is positioned in the application chamber 11. After all, the sausage meat adhering to the rails 24 is continuously exposed to microwave radiation, since in this case it is no longer moved out of the application chamber 11 or out of this region, respectively. Said sausage meat is thus excessively heated, right up to being burned. This increasing temperature inevitably also leads to an increase in the temperature of the rail, in particular in the thin region 27 of the legs 32, where the sausage meat may adhere, since the respective legs above and below the conveyor belts 18, 19 are covered by the adjacent conveyor belts 18, 19, all. Since the measuring units 28, 29 identify the outer sides of the legs across an extensive area, it is consequently also possible to identify an increase in temperature very accurately which may occasionally be local only.

The recorded measured values are correspondingly processed either in the measuring units 28, 29, themselves, or in the controller 6 and compared with a corresponding comparison value or reference value which defines a potential temperature tolerance. If the measured values are smaller than the comparison or reference value, no relevant increase in temperature is present and operation may continue. However, if comparatively high measured values have been determined, the controller 6 will immediately stop further operation in particular of the microwave generation unit 12 and of the conveying unit 17, in order to avoid further heating which, in the extreme case, could lead to smoke being generated or to combustion of the adhering pollution, and to enable cleaning. In such a case, it goes without saying that also a corresponding alarm, be it visual or acoustic, will be emitted in order to inform the user.

As is shown in FIG. 7, the measuring units 28 and 29 are installed in different ways. The measuring units 28 are all located on the movable part 8 of the microwave applicator 7. Corresponding fastening receptacles 33 into which the measuring units 28 can be accordingly inserted or screwed, respectively, are provided on the part 8. The respective optical measuring system identifies the corresponding outer side of the leg 32. Consequently, if the part 8 is opened, the measuring units 28 are accordingly entrained.

The measuring units 29, see FIG. 7, are disposed on a remote position on suitable fastening receptacles 35 on the hollow conductors 13, see also FIG. 4 in this context. The measuring range 31 which is directed toward the respective rail 24 or toward the leg 32, respectively, extends through a corresponding bore 36 in the respective hollow conductor 13. The hollow conductor 13 is inevitably hollow and opens directly into the application chamber 11, such that the measuring range 31 can be readily defined.

On account of this arrangement, on the one hand, each measuring unit 28, 29 is located outside the range radiation, on the other hand, an identification of the outer side of the leg 32 over an extensive area for determining the temperature is nevertheless possible. It goes without saying that the measuring units 28, 29 communicate with the controller 6, such that the latter can correspondingly control the operation of the device depending on the identified measured values.

Notwithstanding the description of non-contacting optical measuring units 28, 29 based on infrared measuring units in the exemplary embodiment, it is conceivable for contacting measuring units, again based on optical principles, however, to be used. In this case, the outer sides of the two legs 32 would have to be connected to the ends of corresponding glass fibers or bundles of glass fibers or similar, in order to enable “optical access”, so to speak. Preferably, however, the described measuring units which operate in a non-contacting manner are employed.

The exemplary embodiment shown describes four application chambers 11 which are in each case assigned one pair of measuring units 28, 29. In principle, it is also conceivable for also only one application chamber or only two application chambers having assigned measuring units 28, 29 to be provided. The specific number of provided application chambers 11 ultimately depends on how powerful the respective microwave generation units 12, that is to say the magnetrons, are. The requirement is always for so much microwave energy to be applied in one application chamber 11 or the cascade of chambers, respectively, that the twists 4 are embrittled so much that they break up.

It is furthermore conceivable for two application chambers to be supplied via a common microwave generation unit, thus to consequently provide only two microwave generation units 12 in the shown exemplary embodiment.

It is furthermore conceivable for each microwave generation unit 12 to be separately controlled, in order to set an energy gradient across the conveying length, so to speak. In this manner it is conceivable for the first microwave generation unit in the conveying direction to be operated at high power, in order to apply a high density of energy already in the entry region, and for the downstream microwave generation units 12 to be in each case operated at somewhat lower power, such that, in consequence, power decreases in steps toward the last microwave generation unit 12.

Finally, the cross-sectional geometry of the rails 24 is not limited to a C-shaped cross section. The rectangular cross section is advantageous in as far as faces which are planar and which can be identified across an extensive area by the measuring units 28, 29 are present on the legs 32. In principle, it would also be conceivable for rounded faces to be provided there, such that, in consequence, a basically U-shaped cross section would also be conceivable. In this case, too, there is the possibility for both rails to be disposed so as to abut one another and for a corresponding hollow space to be configured. Alternatively, it would also be conceivable for only one rail to be embodied in a C-shape, but in this case having longer lateral legs, while the other rail would be embodied as a plate which is correspondingly attached.

Overall, the device according to the invention, having at least one, preferably the two integrated measuring units, offers the possibility of implementing a monitoring of the temperature in the interior of the application chamber and of controlling the operation depending on the prevailing temperature. Thereby any potential pollution which is to be removed can be identified in a rapid and unerring manner; even fire prevention can be thereby implemented.

1. A device for treating a string of sausages composed of a plurality of sausages which are disposed so as to be behind one another, having a sausage casing from an organic material which in the region between two sausages displays in each case a twist, wherein at least one microwave applicator which has at least one application chamber and is assigned at least one microwave generation unit for generating the microwave radiation to be supplied to the application chamber, and which has at least one conveying unit for conveying the string of sausages through the at least one application chamber is provided, wherein at least one measuring unit for identifying at least one measured value which represents a measure of the temperature prevailing in the application chamber provided.

2. The device according to claim 1, wherein the measuring unit identifies the measured value as a measured value of temperature directly in the interior of the application chamber.

3. The device according to claim 1, wherein the measuring unit identifies the measured value as a measured value of temperature of a component which lines or delimits the application chamber.

4. The device according to claim 3, wherein two measuring units which are disposed at different positions and which identify in each case a measured value of temperature of the or of in each case one component are provided.

5. The device according to claim 3, wherein the measuring unit identifies the measured value of temperature on the outer side of the component.

6. The device according to claim 3, wherein the measuring unit is an optical measuring unit which operates in a non-contacting manner, in particular an infrared measuring unit, or that the measuring unit is a measuring unit which bears on the component in a contacting manner, in particular glass fibers which bear on the component in a comprehensive manner.

7. The device according to claim 3, wherein the or each component is a rail which is composed of a material which is transparent to microwave radiation and is releasably disposed in the microwave applicator, and adjacent to which the string of sausages runs in the application chamber serves.

8. The device according to claim 7, wherein two rails which display a C-shaped cross section and are disposed so as to face one another in the microwave applicator in such a manner that, at least in the application chamber, they form a tubular hollow space through which the string of sausages runs are provided.

9. The device according to claim 7, wherein the or at least one of the two rails, at least in portions, in the region which is disposed in the application chamber, display/displays a lesser wall thickness than in other regions.

10. The device according to claim 8, wherein the microwave applicator is composed of two parts, which are movable apart for opening, wherein the one part is positionally fixed and is connected to a hollow conductor which leads to the microwave generation unit, while the other part is movably mounted, and wherein the measuring unit which measures the temperature on the outer side of the rail is disposed on the movable part and, by way of an optical measuring system, is directed toward the rail or is guided through the part to the rail.

11. The device according to claim 8, wherein the microwave applicator is composed of two parts, which are movable apart for opening, wherein the one part is positionally fixed and is connected to a hollow conductor which leads to the microwave generation unit, while the other part is movably mounted, and that the optional second measuring unit is disposed outside the hollow conductor and is either, by way of an optical measuring system, directed through the hollow conductor toward the rail or is guided through the hollow conductor to the rail.

12. The device according to claim 7, wherein the each rail is from polytetrafluoroethylene, schist, fused quartz, aluminum oxide, zirconium oxide, or ceramic based on aluminum oxide or zirconium oxide.

13. The device according to claim 1, wherein a plurality of application chambers which are disposed so as to be behind one another and which are supplied microwave radiation from a common microwave generation unit or in each case separate microwave generation units are provided, wherein at least one part, preferably each application chamber, is assigned at least one measuring unit.

14. The device according to claim 7, wherein the rail or both rails run through a plurality of application chambers.

15. The device according to claim 1, wherein the conveying unit, which comprises two conveyor belts which are disposed so as to be on top of one another and which receive the string of sausages between them, runs through the one application chamber or the plurality of application chambers, in particular the hollow space.

16. The device according to claim 15, wherein the conveyor belts are from silicone or display a silicone coating.

17. The device according to claim 1, wherein a controller which upon identification of a measured value which indicates a temperature which exceeds a reference value switches off the one microwave generation unit or the plurality of microwave generation units is provided.
